(19) United States
(12) Patent Application Publication
(10) Pub. No.: US 2008/0273600 A1
(43) Pub. Date: Nov. 6, 2008

(54) METHOD AND APPARATUS OF WIRELESS COMMUNICATION OF UNCOMPRESSED VIDEO HAVING CHANNEL TIME BLOCKS

(75) Inventors: Harkirat Singh, Santa Clara, CA (US); Huai-Rong Shao, San Jose, CA (US); Xiangping Qin, San Jose, CA (US); Chiu Ngo, San Francisco, CA (US)

Correspondence Address: KNOBBE MARTENS OLSON & BEAR LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 11/743,013

(22) Filed: May 1, 2007

(51) Int. Cl. H04N 11/02

(52) U.S. Cl. 375/240.26; 375/E07.026

(57) ABSTRACT

A method and system for transmission of uncompressed video information from a sender to a receiver over wireless channels is disclosed. For example, according to one embodiment, a time division multiple access method is used to allocate channel time blocks (CTBs) of a wireless channel to a particular transmitting device. If the transmitting device encounters a data underflow condition in which insufficient data for filling a reserved CTB is available for transmission, alternate data is identified for transmission during the otherwise unused reserved time period. Accordingly, embodiments include systems and methods of using such partially utilized CTBs.

### BACKGROUND OF THE INVENTION

1. Field of the Invention

The present invention relates to wireless transmission of video information, and in particular, to transmission of uncompressed high definition video information over wireless channels.

2. Description of the Related Technology

With the proliferation of high quality video, an increasing number of electronic devices, such as consumer electronic devices, utilize high definition (HD) video which can require multiple gigabits per second (Gbps) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer from interference issues when several devices that do not have reserved bandwidth to carry the uncompressed HD signals are connected to the network. Accordingly a need exists for improved methods and devices of wirelessly transferring uncompressed HD signals.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Inventive Embodiments” one will understand how the features of this invention provide advantages that may include improved link robustness under poor channel conditions and reduced retransmissions, thereby improving channel efficiency.

One embodiment comprises a method of transmitting uncompressed video. The method includes identifying uncompressed video data for transmitting on a first device at a first transmission rate during at least one reserved time period. The method further includes determining that transmitting the identified uncompressed video data at the first rate would not utilize at least a portion of the reserved time period. The method further includes identifying additional data to transmit during the portion of the reserved time period.

One embodiment comprises a system for transmitting uncompressed video. The system includes a first transmitter configured to transmit uncompressed video data. The system furthers includes at least one processor configured to identify uncompressed video data for transmitting by the first transmitter at a first transmission rate during at least one reserved time period, determine that transmitting the identified uncompressed video data would not utilize at least a portion of the reserved time period, and identify additional data to transmit during the portion of the reserved time period.

One embodiment comprises a system for transmitting uncompressed video. The system includes means for transmitting uncompressed video data and means for processing. The means for processing is configured to identify uncompressed video data for transmitting by the first transmitter at a first transmission rate during at least one reserved time period, determine that transmitting the identified uncompressed video data would not utilize at least a portion of the reserved time period, and identify data to transmit during the portion of the reserved time period.

### BRIEF DESCRIPTION OF THE DRAWINGS

FIG. 1 is a functional block diagram of a wireless network that implements uncompressed HD video transmission between wireless devices according to one embodiment of the system and method.

FIG. 2 is a functional block diagram of an example communication system for transmission of uncompressed HD video over a wireless medium, according to one embodiment of the system and method.

FIG. 3 is a functional block diagram illustrating an example of a transmitter such as found in the wireless network of FIG. 1.

FIG. 4 is a functional block diagram illustrating an example of a receiver such as found in the wireless network of FIG. 1.

FIG. 5 is a diagram illustrating the structure of a superframe used in the wireless network of FIG. 1

FIG. 6 is a flowchart illustrating one embodiment of a method of utilizing bandwidth in the wireless network of FIG. 1.

FIG. 7 illustrates the structure of a superframe utilizing unused bandwidth according to one embodiment of the method illustrated in FIG. 6 in which a portion of a reserved channel block is utilized by transmitting at a lower PHY rate.

FIG. 8 illustrates the structure of a superframe utilizing unused bandwidth according to another embodiment of the method illustrated in FIG. 6 in which a portion of a reserved channel block is utilized for transmitting beam track data.

FIG. 9 illustrates the structure of a superframe utilizing unused bandwidth according to one embodiment of the method illustrated in FIG. 6 in which a portion of a reserved channel block is utilized for transmitting low rate data.

FIG. 10 illustrates the structure of a superframe utilizing unused bandwidth according to another embodiment of the method illustrated in FIG. 6 in which a portion of a reserved channel block is utilized for transmitting control messages.

FIG. 11 illustrates the structure of a superframe utilizing unused bandwidth according to one embodiment of the method illustrated in FIG. 6 in which a portion of a reserved channel block is utilized by releasing the channel reservation so that the portion can be utilized for unreserved channel block.

FIG. 12 illustrates the structure of a superframe utilizing unused bandwidth according to another embodiment of the method illustrated in FIG. 6 in which a portion of a reserved channel block is utilized for transmitting block scheduling data.

FIG. 13 illustrates the structure of a superframe utilizing unused bandwidth according to one embodiment of the method illustrated in FIG. 6 in which a portion of a reserved channel block is utilized by transmitting duplicate data to provide protection against poor link quality.

FIG. 14 illustrates the structure of a superframe utilizing unused bandwidth according to another embodiment of the method illustrated in FIG. 6 in which a portion of a reserved channel block is utilized to retransmit subpackets.

FIG. 15 is a flowchart illustrating a method of utilizing a superframe such as illustrated in FIG. 14.

### DETAILED DESCRIPTION OF CERTAIN INVENTIVE EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

Certain embodiments provide a method and system for transmission of uncompressed HD audio and video information from a sender to a receiver over wireless channels. For example, according to one embodiment, a time division multiple access method is used to allocate channel time blocks (CTBs) of a wireless channel to a particular transmitting device. However, the transmitting device may at times encounter a data underflow condition in which insufficient data for filling a CTB is available for transmission. Accordingly, embodiments include systems and methods of using such partially utilized CTBs.

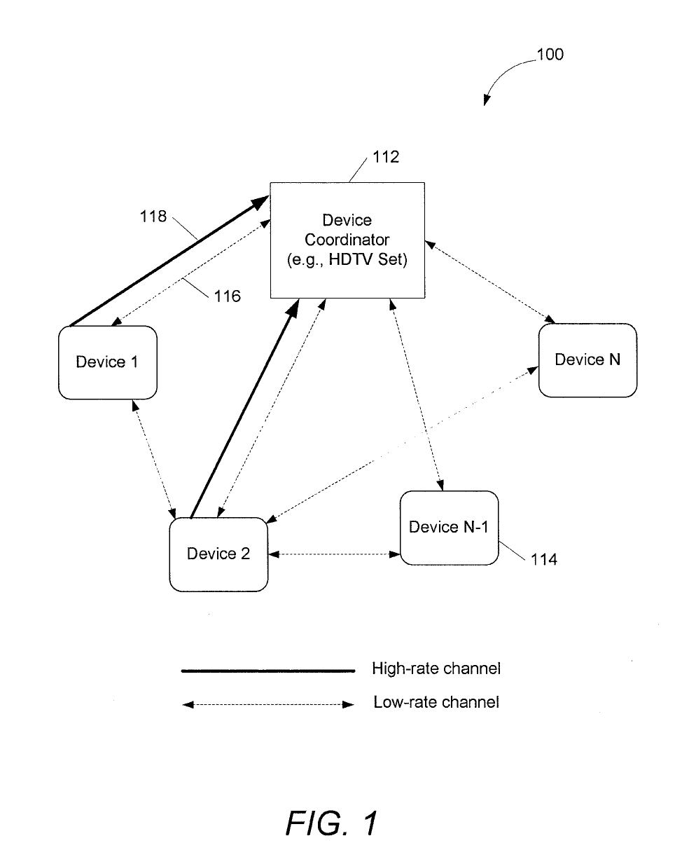

Example implementations of the embodiments in a wireless high definition (HD) audio/video (A/V) system will now be described. FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1 . . . Device N).

The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118, for communication with the stations 114. Each station 114 uses the low-rate channel 116 for communications with other stations 114. The high-rate channel 118 supports single direction unicast transmission over directional beams established by beamforming, with e.g., multi-Gb/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. Time division duplexing (TDD) is applied to the high-rate and low-rate channel. At any one time, the low-rate and high-rate channels cannot be used in parallel for transmission, in certain embodiments. Beamforming technology can be used in both low-rate and high-rate channels. The low-rate channels can also support omni-directional transmissions.

In one example, the device coordinator 112 is a receiver of video information (hereinafter “receiver 112”), and the station 114 is a sender of the video information (hereinafter “sender 114”). For example, the receiver 112 can be a sink of video and/or audio data implemented, such as, in an HDTV set in a home wireless network environment which is a type of WLAN. The sender 114 can be a source of uncompressed video or audio. Examples of the sender 114 include a set-top box, a DVD player or recorder, digital camera, camcorder, and so forth.

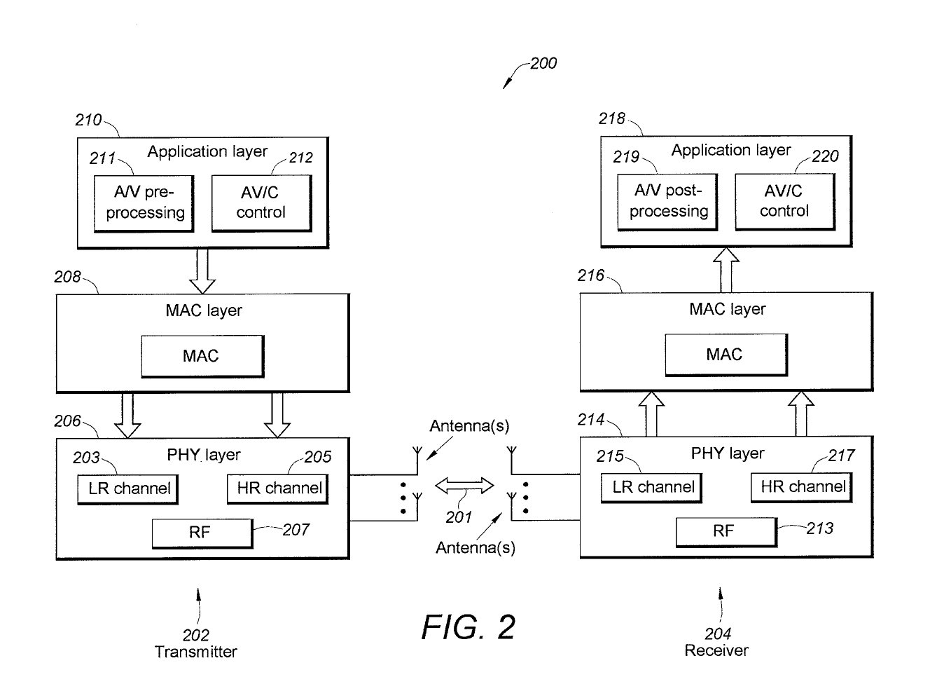

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216, process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

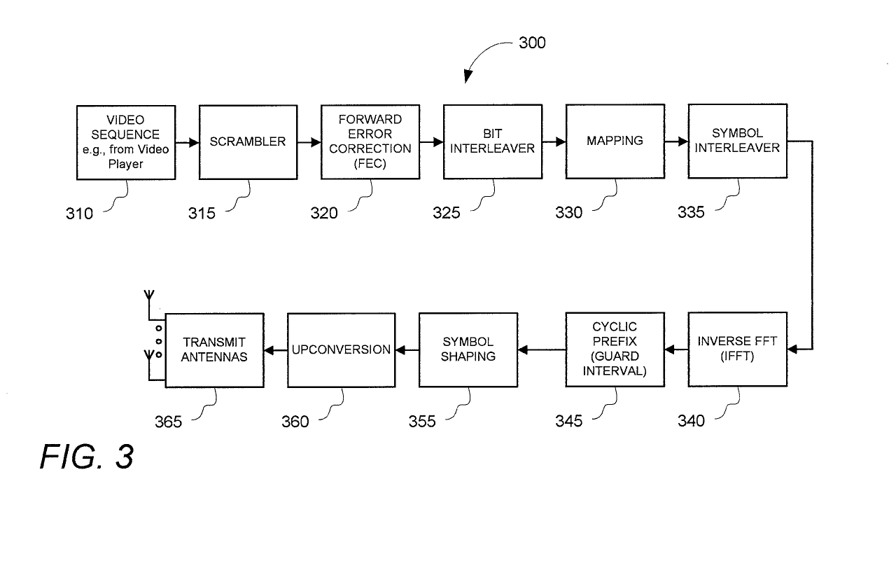

FIG. 3 is a functional block diagram illustrating an example of a transmit chain 300 comprising modules, subsystems or devices, such as used in the PHY block 206 (FIG. 2). It will be appreciated that these modules, subsystems, or devices can be implemented using hardware, software or a combination of both. A video sequence 310 having video data, such as from a video player or other device, is input into a scrambler 315. The scrambler 315 transposes or inverts signals or otherwise encodes data to make the data unintelligible at a receiver not equipped with a corresponding descrambling device. Scrambling is accomplished by the addition of components to the original signal or the changing of some important component of the original signal in order to make extraction of the original signal difficult. Examples of the latter can include removing or changing vertical or horizontal sync pulses in video signals.

A forward error correction (FEC) subsystem 320 receives output from the scrambler and provides protection against noise, interference and channel fading during wireless data transmission. The FEC subsystem 320 adds redundant data to the scrambled video data input to the subsystem. The redundant data allows the receiver to detect and correct errors without asking the transmitter for additional data. In adding redundant data to the video data, the FEC subsystem 320 can use various error correction codes, such as a Reed-Solomon (RS) encoder and a convolutional code (CC) encoder. In other embodiments, the FEC subsystem 320 may use various other encoders, including, but not limited to, a LDPC encoder, a Hamming encoder, and a Bose, Ray-Chaudhuri, Hocquenghem (BCH) encoder.

The output of the FEC 320 is sent to a bit interleaver 325. The bit interleaver 325 rearranges a sequence of data bits received from the FEC 320. The bit interleaver 325 serves to provide further error-protection over video data transmitted over a wireless medium. The output of the bit interleaver 325 is sent to a mapper 330. The mapper 330 maps data bits to complex (IQ) symbols. The complex symbols are used to modulate a carrier for the wireless transmission described above. The mapper 330 can use various modulation schemes, including, but not limited to, Binary Phase-Shift Keying (BPSK), Quadrature Phase-Shift Keying (QPSK), and Quadrature Amplitude Modulation (QAM). In one embodiment, the mapper 330 is a QAM mapper, for example, a 16-QAM mapper or 64-QAM mapper. QAM is a modulation scheme which conveys data by modulating the amplitude of two carrier waves. The two waves, usually two orthogonal sinusoids, are out of phase with each other by 90° and thus are called quadrature carriers. The number, 16 or 64, in front of “QAM” refers to the total number of symbols to which the mapper can map groups of data bits. For example, a 16-QAM mapper converts 4-bit data into 2̂4=16 symbols. Typically, for QAM mappers, a constellation diagram is used for representing the collection of such symbols.

The output of the mapper 330 is sent to a symbol interleaver 335 that rearranges the sequence of complex symbols output from the mapper. The illustrated symbol interleaver 335 is positioned after the mapper 330. In other embodiments, the symbol interleaver 335 may be positioned between the FEC and the mapper 330 in place of the bit interleaver. In such embodiments, the symbol interleaver permutes the predetermined number of bits as a symbol group. For example, in an embodiment where a QAM mapper maps four data bits to a complex symbol, the symbol interleaver is configured to interleave groups of four data bits.

In an embodiment where the symbol interleaver 335 is positioned after the mapper 330, the symbol interleaver rearranges the sequence of the symbols output from the mapper 330. In one embodiment, the symbol interleaver 335 can include a random interleaver which employs a fixed random permutation order and interleaves symbols according to the permutation order. For example, the random interleaver may use Radix-2 FFT (fast Fourier transform) operation. In other embodiments, the symbol interleaver 335 can include a block interleaver. A block interleaver accepts a set of symbols and rearranges them without repeating or omitting any of the symbols in the set. The number of symbols in each set is fixed for a given interleaver. The interleaver's operation on a set of symbols is independent of its operation on all other sets of symbols.

The output of the symbol interleaver 335 is sent to an inverse Fast Fourier Transform (IFFT) module 340. The IFFT 340 transforms frequency domain data from the error-correcting, mapping and interleaving modules back into corresponding time domain data. The IFFT module 340 converts a number of complex symbols, which represent a signal in the frequency domain, into the equivalent time domain signal. The IFFT module 340 also serves to ensure that carrier signals produced are orthogonal. The output of the IFFT 340 is sent to a cyclic prefix adder 345 so as to decrease receiver complexity. The cyclic prefix adder 345 may also be referred to as a guard interval inserter. The cyclic prefix adder 345 adds a cyclic prefix interval (or guard interval) to an IFFT-processed signal block at its front end. The duration of such a cyclic prefix interval may be 1/32, 1/16, ⅛, or ¼ of the original signal block duration, depending on expected channel conditions and receiver cost and complexity.

At this point of the transmit chain 300, a preamble is part of the header 310 and prior to the IFFT-processed signal block. Generally, a preamble is selected by the designers of the system 200, such as previously described, and is standardized so that all devices of the system understand it. The preamble is used to detect start of the packet, estimate various channel parameters, such as symbol timing, carrier frequency offset.

A symbol shaping module 355 interpolates and low-pass filters the packet signal generated from the IFFT module 340, the cyclic prefix adder 345 and the preamble. The output of the symbol shaping module 355 is a complex baseband of the output signal of the IFFT module 340. An upconverter 360 upconverts the output of the symbol shaping module 355 to a radio frequency (RF) for possible meaningful transmission. A set of transmit antennas 365 transmit the signal output from the upconverter 360 over a wireless medium, such as the wireless channel 201 (FIG. 2) to a receiver. The transmit antennas 365 can include any antenna system or module suitable for wirelessly transmitting uncompressed HD video signals.

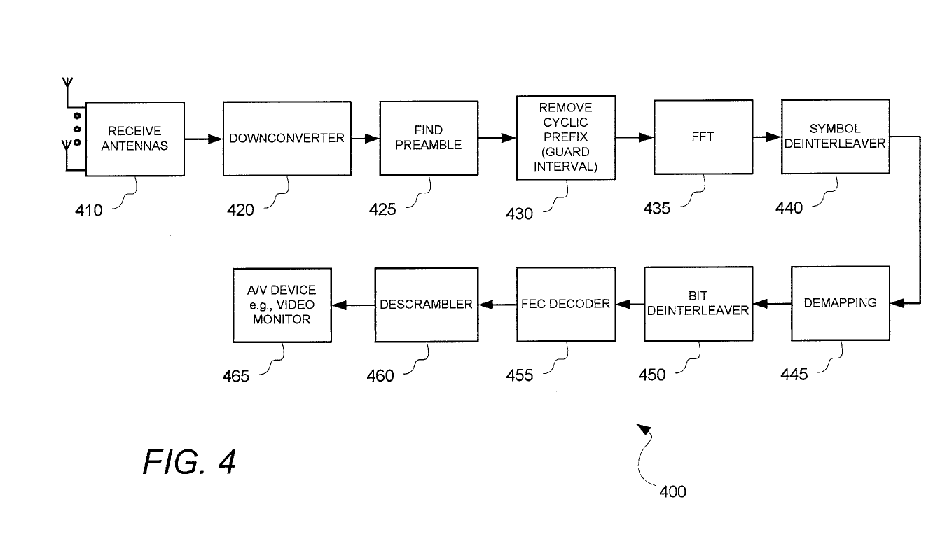

FIG. 4 is a functional block diagram illustrating a receiver chain 400 of modules, subsystems or devices, such as used in the PHY block 214 (FIG. 2). The receiver chain 400 generally performs an inverse process of that of the transmitter chain 300 of FIG. 3. The receiver 400 receives an RF signal via the wireless channel 201 (FIG. 2) at receive antennas 410 from the transmit antennas 365 of the transmitter chain 300. A downconverter 415 downconverts the RF signal to a signal of a frequency suitable for processing, or the baseband signal, which is already in the digital domain for easy digital signal processing. A preamble finder 420 then locates a preamble portion of the digital signal, finds the symbol starting timing, estimates the channel coefficients, estimates the carrier frequency offset and tries to compensate it via local processing. In certain embodiments, the preamble finder 420 includes a correlator and a packet start finding algorithm that can operate on the short training sequences of the preamble. After the preamble is identified by the finder 420, the preamble portion of a current signal packet is sent to a channel estimation, synchronization and timing recovery component 425, which will be further described below. A cyclic prefix remover 430 removes the cyclic prefix from the signal. Next, a fast Fourier transform (FFT) module 435 transforms the signal (a time-domain signal) into a frequency-domain signal. The output of the FFT 435 is used by a symbol deinterleaver 440 which rearranges the FFT output for a demapper 445. The demapper 445 converts the frequency-domain signal (a complex signal) into a bit stream in the time domain. A bit deinterleaver 450 rearranges the bit stream in the original bit stream sequence as before the bit interleaver 325 of FIG. 3.

Subsequently to the bit deinterleaving, a FEC decoder 455 decodes the bit stream, thereby removing redundancy added by the FEC 320 of FIG. 3. In one embodiment, the FEC decoder 455 includes a demultiplexer, a multiplexer, and a plurality of convolutional code (CC) decoders interposed between the demultiplexer and the multiplexer. Finally, a descrambler 460 receives the output from the FEC decoder 455, and then descrambles it, thereby regenerating the video data sent from the transmitter chain 300 of FIG. 3. A video device 465 can now display video using the video data. Examples of the video device include, but are not limited to, a CRT monitor, an LCD monitor, a rear-projection monitor, and a plasma display. It will be appreciated that audio data can also be processed and transmitted in the same manner along with video data by the wireless HD A/V system described above. The audio data can be processed and transmitted using a different wireless transmission scheme. The descrambler 460, FEC decoder 455, bit deinterleaver 450, demapper 445, symbol deinterleaver 440, FFT 435 cyclic prefix remover 430, down-converter 415 and receive antennas 410 of the receiver chain 400 perform analogous but inverse functions of the corresponding scrambler 315, FEC 320, bit interleaver 325, mapper 330, symbol interleaver 335, IFFT 340, cyclic prefix adder 345, upconverter 360 and transmit antennas 365 of the transmit chain 300.

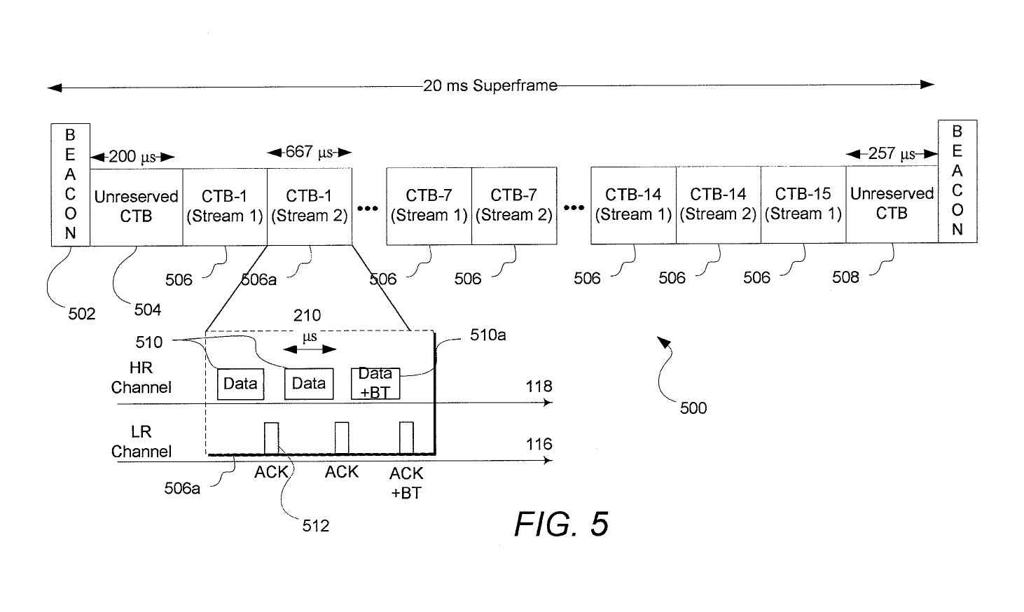

FIG. 5 illustrates an example of a superframe 500 structure transmitted by one embodiment of the MAC layer 208 of FIG. 2. Each superframe 500 may be divided into a number of channel time blocks (CTBs). For example, the illustrated superframe 500 includes a beacon period 502, an unreserved CTB that acts as a control period 504, a number of reserved CTBs 506, and an unreserved CTB 508. It is to be recognized that particular superframes may have different numbers and sequences of reserved CTBs 506 and unreserved CTBs 508. The beacon period 502 may be used to allocate reserved and unreserved CTBs 504/506 in the superframe 500. A device coordinator 112, such as a video display, for example, communicates reserved time slots to the multiple client devices 114 in a network such as the network 100 in FIG. 1.

The control period 504 may be used to allow client devices to transmit control messages to the device coordinator 112. Control messages may include network/device association and disassociation, device discovery, time slot reservations, device capability and preference exchanges, etc. The control period 504 may use a contention based access system such as Aloha, slotted Aloha, CSMA (carrier sensed multiple access), etc., to allow multiple devices to send control messages and to handle collisions of messages from multiple devices. When a message from a client device is received at a device coordinator 112 without suffering a collision, the device coordinator 112 can respond to the request of the message in the beacon period 502 of a subsequent superframe 500. The response may be a time slot reservation of a particular CTB 506 in one or more subsequent superframes 500.

The CTBs 506 are used for transmissions other than beacon messages and contention based control messages which are transmitted in the beacon period 502 and the control period 504. Reserved CTBs 506 are used to transmit commands, isochronous streams and asynchronous data connections. CTB's 506 can be reserved for transmission by a coordinator device to a specific client device, for transmission by a client device to a device coordinator, for transmission by a client device to another client device, etc. A particular CTB 506 can be used to transmit a single data packet or multiple data packets and can include any number of reserved or unreserved CTB's. Unreserved CTB's 508 in the CTB frame 510 can be used for communication of further contention based commands on the low-rate channel such as remote control commands (e.g., CEC commands), MAC control, and management commands.

It is desirable to make the length of the control period 504 as small as possible while still allowing many client devices to be able to successfully access the network without undo time delay, e.g., due to message collision. In one embodiment, the only messages that are sent on a contention basis are control initiation request messages that identify a requesting device and a type of message sequence exchange to be scheduled in a reserved CTB. In this way, the size of the messages that are contention-based are kept to a minimum. All other message exchanges on the low-rate channel can be scheduled.

In the example superframe 500, the superframe 500 period is 20 ms, the control period 504 is 200 Us, the period of each reserved CTB is 667 Is , and the period of the unreserved CTB 508 is 257. However, the period of CTBs may vary from superframe 500 to superframe 500. In additional, in other embodiments different superframe structures may be used. For example, in one embodiment, the control period 504 is 300 μs. The particular example of the superframe 500 of FIG. 5 illustrates communication of two 1080i video streams, stream 1 and stream 2, (as used herein, a video stream may refer to both the video data and the accompanying audio data) in which CTBs 506 are alternated between each stream. As the example superframe 500 includes an odd number of reserved CTBs to the two streams, the illustrated superframe includes an extra (CTB-15) CTB 506 for stream 1. In one embodiment, the next superframe 500 has a similar structure but with the CTB-15 allocated to stream 2 in order to balance data transmission between the two streams. Any of the beacon period 502, the control period 504 and the CTBs 506 can be either fixed or variable durations, depending on the embodiment. Likewise, the superframe 500 time duration can be fixed or variable, depending on the embodiment.

As further illustrated in FIG. 5, each reserved CTB may be further partitioned into time periods associated with data packets 510 and acknowledgement (ACK) packets 512. In the example CTB 506a, three data packets 510 are sent in 210 μs time periods on the high rate channel 118, each followed by ACK 512 on the low rate channel 116. The particular packet 510a may include beam track (BT) data for controlling the beamforming discussed with reference to FIG. 1. In one embodiment, the low-rate channel 116 is used for transmission during the beacon period 502, and the control period 504. Both the high-rate and low-rate channels are used for transmission during the CTBs 506 and 508.

It has been found that the MAC layer 212 (FIG. 2) may at times find insufficient data to fill all data packets 510 of a particular CTB 506, e.g., transmit buffers have insufficient data, e.g., for at least the data packet 510a, representing an “underflow” condition. Thus, the bandwidth of the system 100 would be unutilized or underutilized during the time period otherwise used by such data packets 510, e.g., data packet 510a.

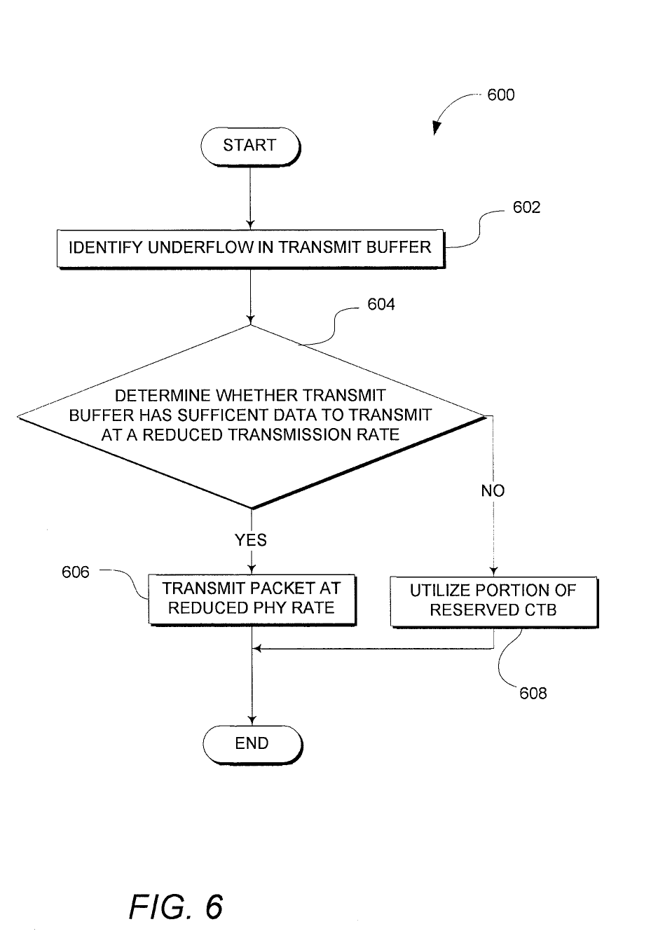

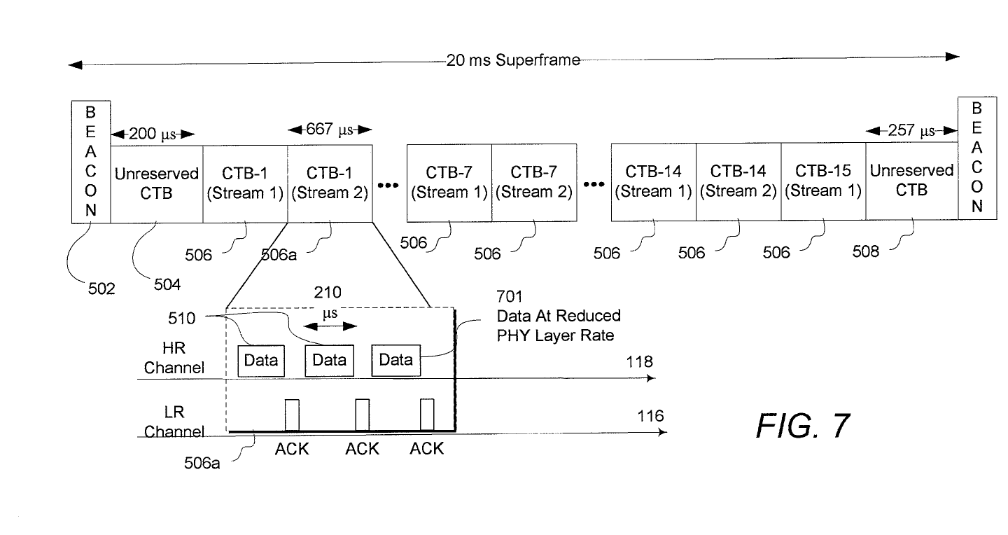

FIG. 6 is a flowchart illustrating one embodiment of a method 600 of utilizing bandwidth in the wireless network 100 during such an underflow condition. The method 600 begins at a block 602 in which the transmitter 202 (FIG. 2) identifies underflow in a transmit buffer. For example, in one embodiment, the transmitter 202 identifies uncompressed video data for transmitting at a first PHY layer transmission rate during at least one CTB 506 and determines that transmitting the identified uncompressed video data would not utilize at least a portion of, e.g., the packet 510a of FIG. 5, of the CTB 506. Next at a block 604, the transmitter 202 determines whether the transmit buffer has sufficient data to transmit at a reduced PHY rate. If it does, the method 600 proceed to the block 606 in which the transmitter 202 transmits the identified uncompressed video data at the reduced rate utilizing substantially all of the reserved CTB 506. If the transmitter 202 determines that it has insufficient data in its transmit buffer to transmit even at a reduced PHY rate, the method 600 proceed to a block 608 in which the transmitter 202 identifies data to transmit during the unused or underutilized portion of the CTB 506. Such data may include control data, beam track data, or any other suitable data including data discussed below with reference to FIGS. 7 to 15.

It is to be recognized that depending on the embodiment, certain acts or events of any of the methods described herein can be performed in a different sequence, may be added, merged, or left out all together (e.g., not all described acts or events are necessary for the practice of the method). Moreover, in certain embodiments, acts or events may be performed concurrently, e.g., through multi-threaded processing, interrupt processing, or multiple processors, rather than sequentially. For example, in one embodiment, the acts and events associated with one or more of the blocks 604 and 606 may not be performed, and the acts and events associated with embodiments of the block 608 are instead performed.

FIG. 7 illustrates the structure of an embodiment of the superframe 500 utilizing unused bandwidth according to one embodiment of the block 606 of FIG. 6. To more fully utilize the bandwidth of the reserved CTB 506a, in the CTB 506a, a data packet 701 is transmitted at a lower physical (PHY) data rate as compared to the other packets 510 of the CTB 506a. Thus, the data of the packet 701 is transmitted using substantially the entire time period of the packet 510, even though it would not have included enough data to use the entire time period due to the underflow of data to be transmitted. Desirably, by being transmitted at a lower rate, the packet 701 has increased resistance to noise or other channel conditions.

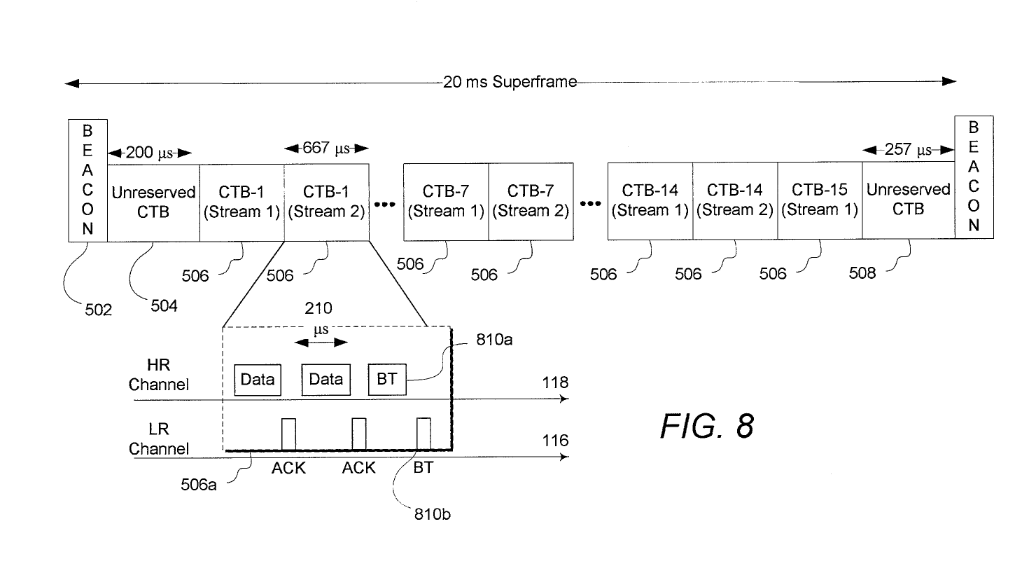

FIG. 8 illustrates the structure of an embodiment of the superframe 500 utilizing unused bandwidth according to one embodiment of the block 608 of FIG. 6. In the embodiment of FIG. 8, the otherwise under or unused time period of block 510a of FIG. 5 is utilized to send beam track data 810a and 810b. This data may be sent on the HR data channel 118 (packet 810a) and/or on the low rate channel 116 (packet 810b). Desirably, the beam track data back 810a, 810b utilizes otherwise unused bandwidth to transmit beam track data. In addition, the additional beam track data 810a, 810b may also desirably improve beamformer performance.

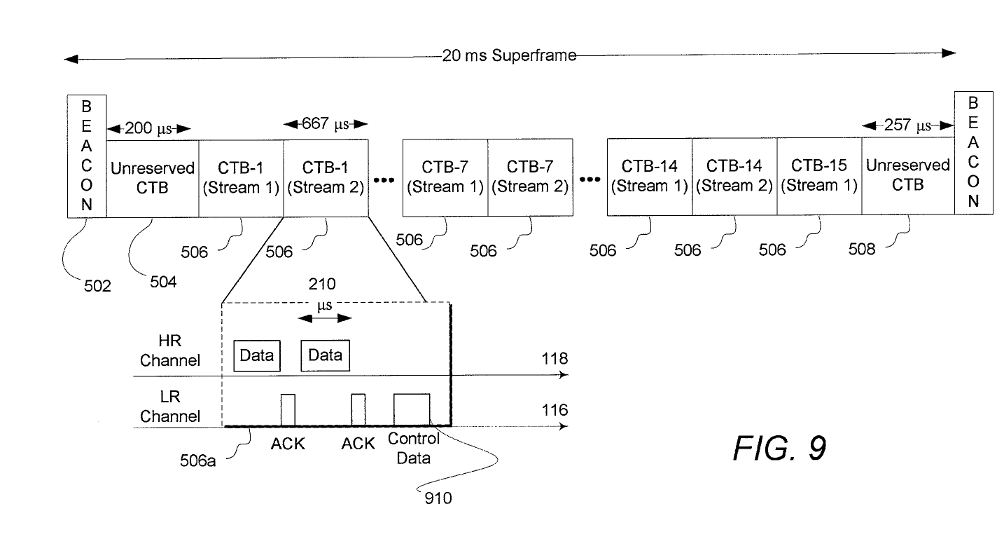

FIG. 9 illustrates the structure of an embodiment of the superframe 500 utilizing unused bandwidth according to one embodiment of the block 608 of FIG. 6. In the embodiment of FIG. 9, the time period of the packet 510 of FIG. 5 is used by, e.g., the coordinator 112 (FIG. 1) to transmit control data 910 on the low rate channel 116, e.g., to send bandwidth reservation responses or other control and/or management information without waiting until the next beacon period 502. Desirably, the control data 910 utilizes otherwise unused bandwidth to transmit control data.

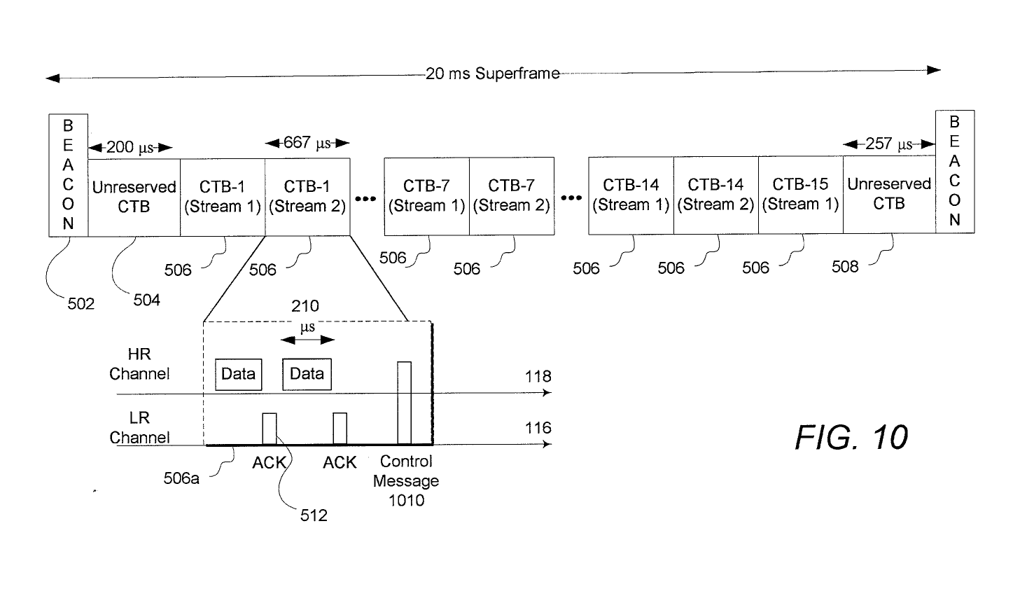

FIG. 10 illustrates the structure of an embodiment of the superframe 500 utilizing unused bandwidth according to one embodiment of the block 608 of FIG. 6. FIG. 10 illustrates an embodiment similar to that of FIG. 9, except that in FIG. 10, the CTB 506a includes a control message packet 1010 that may be sent by the coordinator 112 on either the high rate channel 118 or the low rate channel 116. Desirably, the control message packet 1010 may include an aggregate of responses to control data previously transmitted by the transmitter 202 to the coordinator 112, but to which the coordinator 112 would otherwise wait until the next beacon period 501 to respond. This is particularly desirable in embodiments in which responses from the coordinator 112 may not be aggregated in its acknowledgement message 512. Desirably, in the embodiment illustrated in FIG. 10, the control messages 1010 may be sent to the device transmitting on the high rate channel 118.

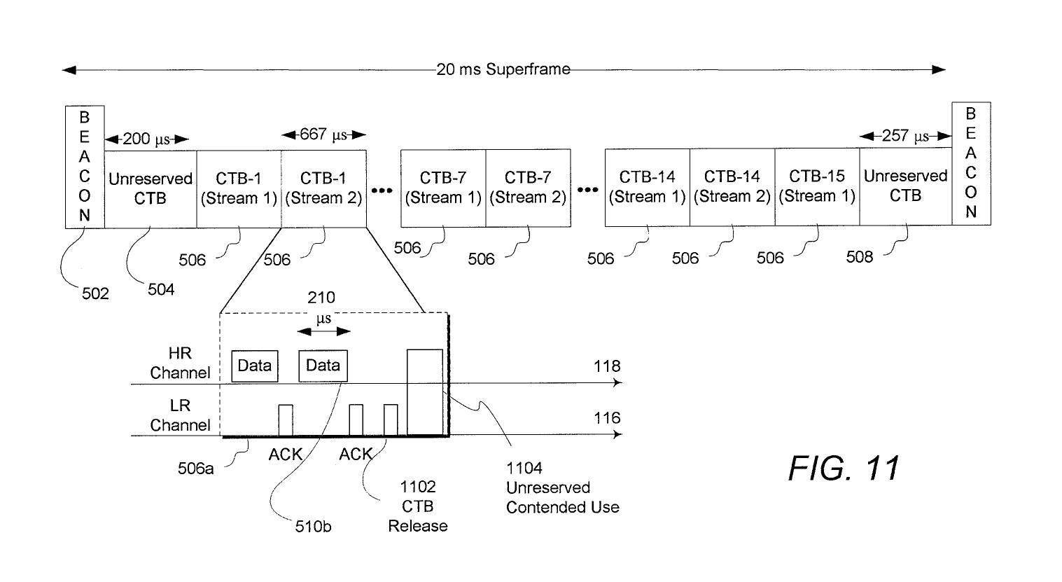

FIG. 11 illustrates the structure of an embodiment of the superframe 500 utilizing unused bandwidth according to one embodiment of the method 600 illustrated in FIG. 6. In the embodiment of FIG. 11, the coordinator 112 sends a CTB release message 1102 (e.g., based on data in the previous packet 510b indicating the underflow condition). The time period 1104 may thus be used by any device in the system 100 as an unreserved CTB 504/508.

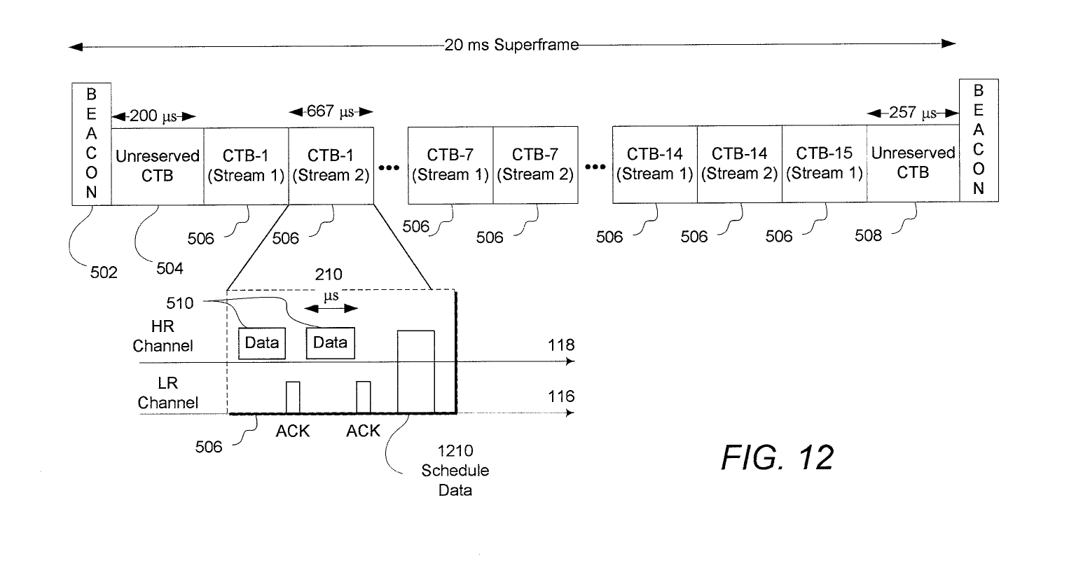

FIG. 12 illustrates the structure of an embodiment of the superframe 500 utilizing unused bandwidth according to one embodiment of the block 608 of FIG. 6. FIG. 12 illustrates an particular embodiment of FIG. 10 in which the CTB 506a includes schedule data 1210, including reserved CTB 506 schedule information to devices 114 in the system 100, that may be sent by the coordinator 112 on either the high rate channel 118 or the low rate channel 116. Desirably, the schedule data 1210 may include data which the coordinator 112 would otherwise wait until the next beacon period 501 to send.

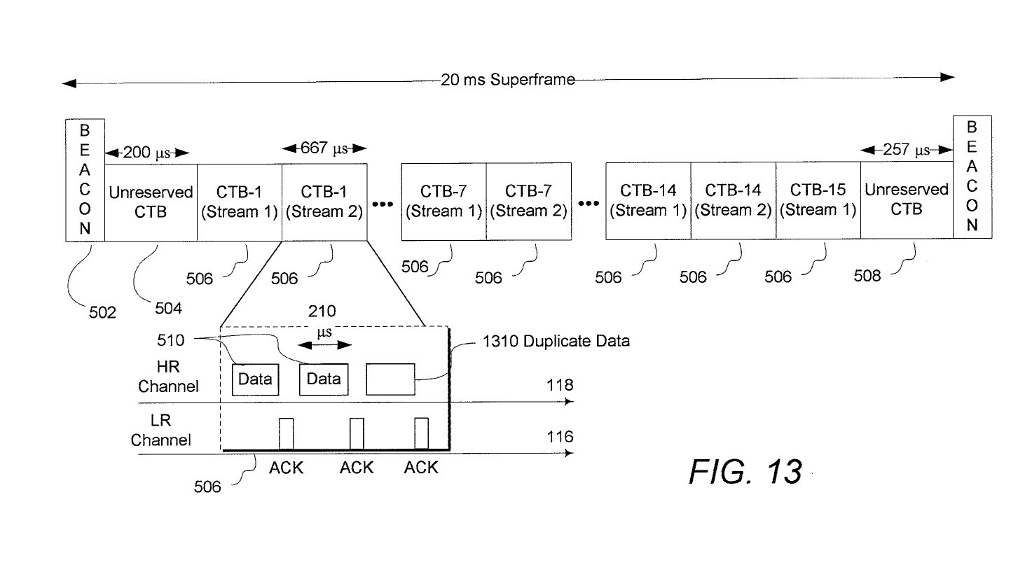

FIG. 13 illustrates the structure of an embodiment of the superframe 500 utilizing unused bandwidth according to one embodiment of the block 608 of FIG. 6. In the embodiment of FIG. 13, the transmitter 202 includes duplicate data such as from the packets 510. Desirably, by transmitting some data (which could be a duplicate of the previous data packet, NULL bits, or any other arbitrarily selected filler data having no specific meaning to AV data processing) during the otherwise unused time period 1310, the transmitter 202 and receiver 204 (FIG. 2) beamformer remains operational (continues beamforming operation) to detect and mitigate channel conditions.

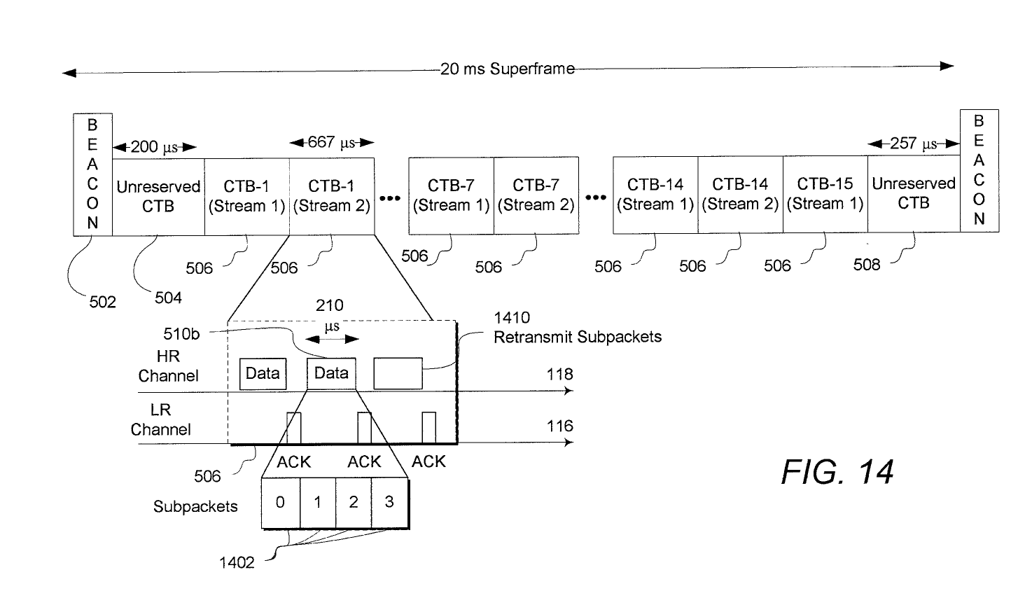

FIG. 14 illustrates the structure of an embodiment of the superframe 500 utilizing unused bandwidth according to one embodiment of the block 608 of FIG. 6. In the embodiment of FIG. 14, the transmitter 202 identifies one or more subpackets 1402 of a prior packet, e.g., the packet 510b, for which negative ACKs were received indicating subpacket errors. The transmitter 202 retransmits such subpackets 1402 during the time period of the retransmission packet 1410 that would otherwise be unutilized due to lack of data to transmit. In one embodiment, fewer than all of the prior subpackets 1402 are retransmitted during the period of the packet 1410. Thus, in order to utilize the entire time period, a lower PHY rate is used to retransmit the subpackets 1402.

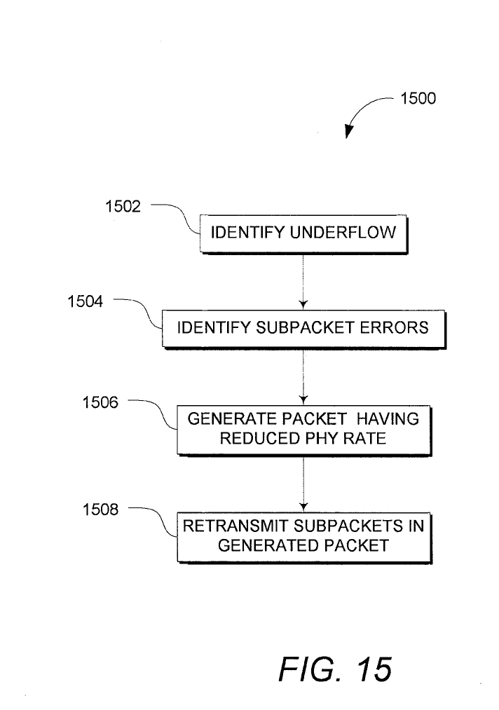

FIG. 15 is a flowchart illustrating a method 1500 of utilizing the superframe 500 such as illustrated in FIG. 14. The method 1500 begins at a block 1502 in which the transmitter 202 identifies an underflow in the transmit buffer. Next at a block 1504, the transmitter 202 identifies one or more subpacket errors from prior data packets 510. Moving to a block 1504, the MAC layer 208 (FIG. 2) of the transmitter 202 generates a packet, e.g., the retransmission packet 1410 of FIG. 14, for retransmitting the subpackets having errors. In one embodiment, if the amount of data is insufficient to fill the time period of the packet 1410 at the prior PHY layer rate, the packet 1410 is generated based on a reduced PHY layer rate so that substantially the entire period of the packet 1410 of FIG. 14 is utilized. Proceeding to a block 1508, the transmitter 202 transmits the generated packet 1410 at a suitable PHY rate to utilized substantially all of the otherwise unused CTB 506a.

Those of skill will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A method of transmitting uncompressed video, the method comprising:
identifying uncompressed video data for transmitting on a first device at a first transmission rate during at least one reserved time period;
determining that transmitting the identified uncompressed video data at the first rate would not utilize at least a portion of the reserved time period, and
identifying additional data to transmit during the portion of the reserved time period.

2. The method of claim 1, further comprising transmitting the identified additional data from the first device at the first transmission rate.

3. The method of claim 1, wherein the identified additional data comprises the identified uncompressed video data, and further comprising:
identifying a second, lower, transmission rate; and
transmitting the identified uncompressed video data at the second transmission rate during substantially all of the reserved time period.

4. The method of claim 1, wherein the identified additional data comprises at least one control packet transmitted on at least of a high rate or a low rate channel.

5. The method of claim 4, further comprising transmitting the identified additional data from a second device.

6. The method of claim 5, wherein the second device transmits the identified data to the first device.

7. The method of claim 5, wherein the second device transmits the identified data to a third device.

8. The method of claim 1, wherein the identified additional data comprises at least one of a duplicate packet or a null packet that provides channel data so as to maintain beamforming operation.

9. The method of claim 1, wherein the identified additional data comprises a retransmitted packet.

10. The method of claim 1, wherein the identified additional data comprises a message releasing the reserved time period.

11. The method of claim 10, further comprising:
transmitting data from a second device during the release time period.

12. The method of claim 1, wherein the identified additional data comprises a beam track data message.

13. The method of claim 1, wherein the identified additional data comprises a control message.

14. The method of claim 13, wherein the control message comprises a schedule information message transmitted by a second device associated with scheduling at least one other reserved time period.

15. A system for transmitting uncompressed video, the system comprising:
a first transmitter configured to transmit uncompressed video data; and
at least one processor configured to:
identify uncompressed video data for transmitting by the first transmitter at a first transmission rate during at least one reserved time period;
determine that transmitting the identified uncompressed video data would not utilize at least a portion of the reserved time period; and
identify additional data to transmit during the portion of the reserved time period.

16. The system of claim 15, wherein the transmitter is configured to transmit the identified additional data from the first transmitter at the first transmission rate.

17. The system of claim 15, wherein the identified additional data comprises the identified uncompressed video data, wherein the processor is further configured to identify a second, lower, transmission rate, and wherein the first transmitter is further configured to transmit the identified uncompressed video data at the second transmission rate during substantially all of the reserved time period.

18. The system of claim 15, wherein the identified additional data comprises at least one control packet transmitted on at least of a high rate or a low rate channel.

19. The system of claim 18, further comprising:
a second transmitter configured to transmit the identified additional data.

20. The system of claim 19, wherein the second transmitter is configured to transmit the identified additional data to a first device associated with the first transmitter.

21. The system of claim 19, wherein the second transmitter is configured to transmit the identified additional data to a second device associated with a third transmitter.

22. The system of claim 15, wherein the identified additional data comprises at least one of a duplicate packet or a null packet that provides channel data so as to maintain beamforming operation.

23. The system of claim 15, wherein the identified additional data comprises a retransmitted packet.

24. The system of claim 15, wherein the identified additional data comprises a message releasing the reserved time period.

25. The system of claim 10, further comprising:
a third transmitter configured to transmit data during the released time period.

26. The system of claim 15, wherein the identified additional data comprises a beam track data message.

27. The system of claim 15, wherein the identified additional data comprises a schedule information message associated with scheduling at least one other reserved time period.

28. A system for transmitting uncompressed video, the system comprising:
means for transmitting uncompressed video data; and
means for processing configured to:
identify uncompressed video data for transmitting by the first transmitter at a first transmission rate during at least one reserved time period;
determine that transmitting the identified uncompressed video data would not utilize at least a portion of the reserved time period; and
identify data to transmit during the portion of the reserved time period.
